(19) United States
(12) Patent Application Publication
(10) Pub. No.: US 2012/0042360 A1
(43) Pub. Date: Feb. 16, 2012

(54) MOBILE SERVICES TAILORED TO USER NEED

(76) Inventor: Rania Abdelqader Massad BAKEIR, Amman (JO)

(21) Appl. No.: 12/856,912

(22) Filed: Aug. 16, 2010

(51) Int. Cl. G06F 21/24

(52) U.S. Cl. 726/4

(57) ABSTRACT

A system for controlling delivery of content to a user in a telecommunications network, includes:
a mobile service provider for providing content and mobile services; and
a mobile device associated with a user, the mobile device having:
a communications interface for communicating with the mobile service provider over the telecommunications network; and
a memory storing a user profile associated with the user which specifies personal information of the user, and a security level associated with the user that shows to what extent the user would like the personal information to be readable by the mobile service providers and to what extent the user would like to receive mobile services and content, or whether the user does not want to accept any mobile services.

### BACKGROUND OF THE INVENTION

1. Field of the Invention

This invention relates to mobile telecommunications, and in particular to mobile services providers with customized delivery of content and mobile services.

2. Description of the Related Art

Today, more and more people possess mobile devices, which enable people to have access to a wide range of services, but also to be contacted anytime, anywhere, which can cause discomfort. Mobile devices now are not only used for talking, but also for watching TV, browsing the Internet and the World Wide Web, chatting with friends, and much more. There is a need for people to have full control of who can reach them and how, depending on their current situation, such as when at work, during a call with a friend, or during a family dinner, in which situation a call related to work is not always appreciated. Furthermore, situation changes need to be detected since preferences typically change often.

Today, third generation (3G) mobile networks have emerged with different and diverse video capabilities. The mobile video environment is widespread while shielding users from the tangle of incompatible handset capabilities of 3G video telephony. Every 3G handset has interactive video capabilities, greatly expanding the range of information delivery that is possible.

The reception of video services over handheld devices is taking shape with a rapidly increasing number of deployments based on different technologies. Now 3G+ networks already offer video-on-demand (VOD) and live streaming content.

### BRIEF SUMMARY OF THE INVENTION

A system and method for mobile devices allow such mobile devices to be tailored to the needs and preferences of the mobile users. A user profile for each mobile user is stored on his/her mobile device that specifies his/her age, gender, interest areas, etc. and a security level for each user that shows to which extent he would like his information to be readable by mobile service providers and to which extent he would like to receive mobile services or whether he does not want to accept any mobile services. This profile is readable by the network administrator when the mobile device accesses a specific network area to start providing each viewer with a set of services tailored to his interests and to be sure to prevent improper or illegal access, for example, to not provide people who are younger than 18 years with content or information they should not or do not need to be exposed to.

### BRIEF DESCRIPTION OF THE SEVERAL VIEWS OF THE DRAWINGS

Preferred embodiments of the invention are disclosed hereinbelow with reference to the drawings.

FIG. 1 is a schematic of the system of the present invention.

FIG. 2 illustrates prevention of illegal delivery of services to a user.

FIG. 3 illustrations prevention of undesired delivery of services to a user.

FIG. 4 illustrates permitted delivery of services to a user.

FIG. 5 is a schematic of various conditions and preferences accessed by profiles.

FIG. 6 is a schematic of various types of content.

### DETAILED DESCRIPTION OF THE INVENTION

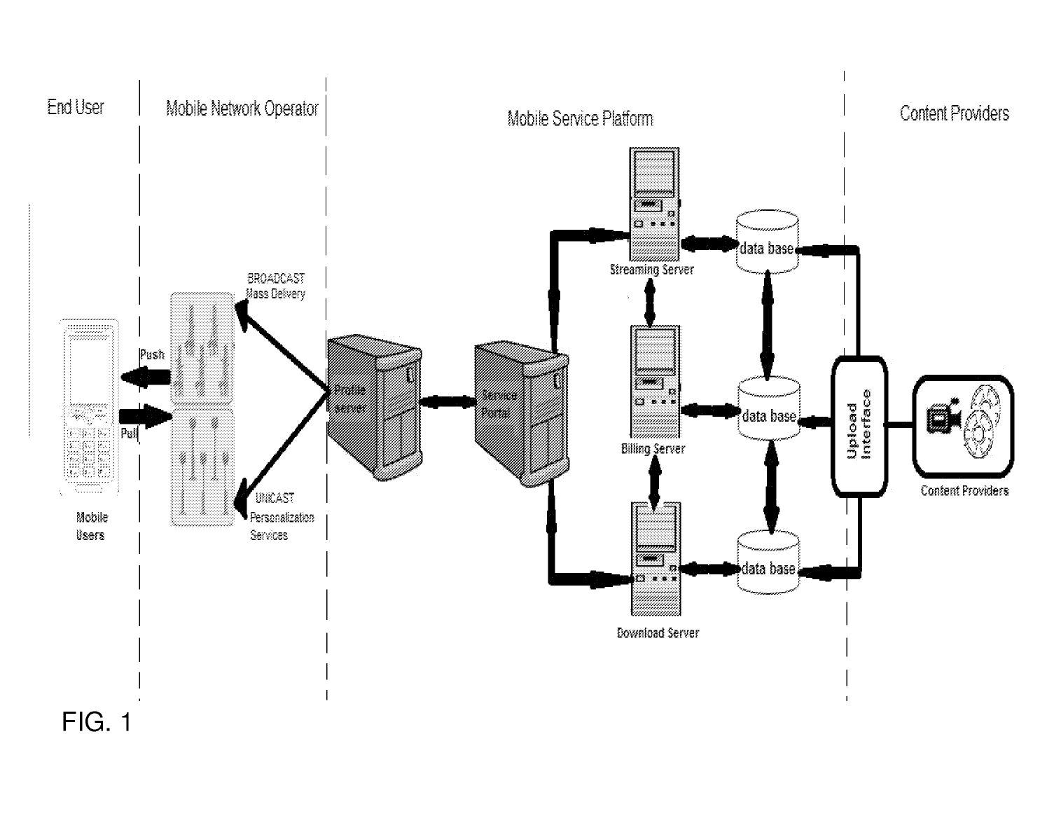

As shown in FIG. 1-6, a system and method for mobile devices allow mobile devices to be tailored to the needs and preferences of the mobile users. As shown in FIG. 1, content providers upload their content through secure upload interfaces to the specific databases, which are accessed by billing servers, streaming servers, and content download servers. The specific servers and databases may form, for example, a mobile video platform, and may interact with each other to coordinate access, billing, and management.

Such content is accessible by the user through a video portal. For example, the user can view the electronic services guide (ESG) of the mobile device, and then request what the user needs or desires. The request of a mobile user for the video content is transferred to the billing module. The request should be transferred to the billing server. Depending on the stored information about the selected content, the billing module decide how to manage the request. Video on demand is a special case of live streaming. The files are sent via upload interfaces to a streaming server database.

For downloading content, information from the file server database is sent back to the billing module in order to apply digital rights management (DRM). The content is then delivered to the mobile handset, for example, through mobile network operators providing a connection between end users and the network operators, and such a connection may be through push and pull operations in a broadcast mode for mass delivery to multiple users, or in a unicast mode for personalization of services for a specific user.

The content download server is used to transfer and save content to the mobile device.

The system and method of the present invention thus provide, control, and manage content from content providers to a end user, through a mobile network operator, and through a mobile video platform which contain on the platform any content aggregator and information regarding spectrum owners and licenses.

While mobile services have taken off on mobile networks, fairly important questions has been neglected by most of the implementors of such mobile services, namely: “How we can ensure that users should really get the content they are supposed to?”, “how we can be sure not to provide people who are younger than 18 years with content and information they are not allowed to or do not need to be exposed to?”, “how we can provide users with special needs with what they really need?”, and “how we can be sure that if we provide the services that the users need, such services will be on time and at the time that the users would like to receive them and will not disturb the users?”. These are the questions and problems that the system and method of the present invention solve.

In implementing the present invention, the answers and solutions for all of the previous questions can be accomplished by having a user profile for each mobile user on his/her mobile device that specifies his/her age, gender, interest areas, etc., and a security level for each user that shows to which extent the user would like his information to be readable by mobile service providers and to which extent the user would like to receive mobile services or whether the user does not want to accept any mobile services.

This user-associated profile is readable by a network administrator, for example, implemented in one or more of the streaming server, billing server, and content download server, or in the mobile network operators, when the mobile device accesses a specific network area to start providing each viewer with a set of services tailored to his interests, and to be sure not to provide people who are younger than 18 years with content or information which they are not allowed to or do not need to be exposed to.

### 1. Mobile Profile

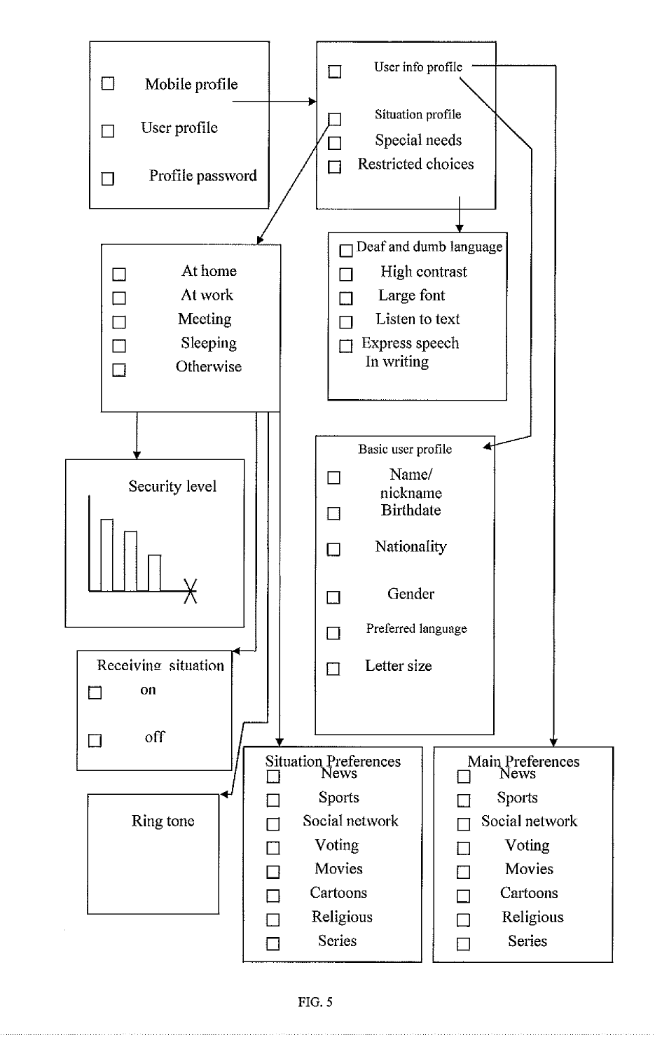

As shown in FIG. 5, each mobile profile provides data that only relates to a specific mobile device. The mobile profile data should be set by the manufacturer and should describe the kind of mobile device, its storage capacity, its screen resolution, its operating system, and other information on the capabilities of the mobile device.

### 2. User Profile

As shown in FIG. 5, each user information profile includes a basic profile of the user and main preferences of the user.

### 2.1.1 Basic Profile

The basic profile of the user contains rules and settings that are always active such as the name, nationality, gender, preferred language, and birth date of the user. The basic profile typically contains descriptive information and some categories of generic settings and preferences. There are a number of user characteristics and preferences that apply independently of any particular product or service, such as the need for enlarged text.

### 2.1.2 Main Preferences

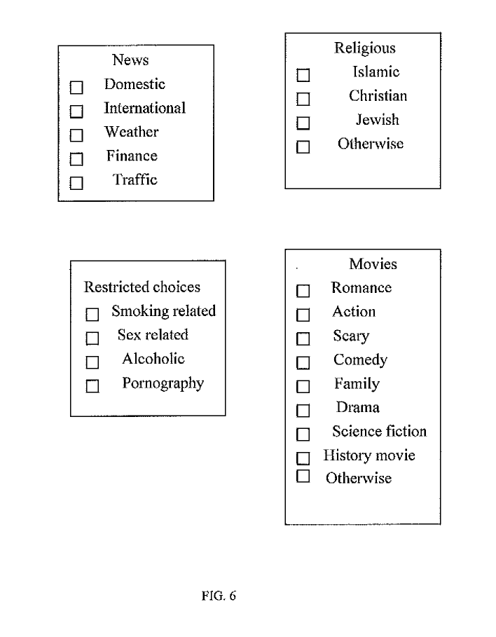

The main preferences of the user are stored as a menu from which the user is going to choose what he is interested in, according to different categories, such as movies, news, sports, weather, cartoons, social network, voting programs, religious, series, etc. This category is going to become more specific in other categories, as shown in FIG. 6, such as news which is going to show more specific categories that contain domestic, international, weather, traffic and finance. The religious category shows Islamic, Christian, Jewish, and otherwise other types of religious categories. The movie category show romance, action, scary, comedy, family, drama, science fiction, history movie, and otherwise other types of movies and media programming, such as television programs. What the user chooses here is going to be what will appear at the situation preferences.

### 2.2. User Situation Profile

As shown in FIG. 5, the user's situations vary during the day from at home to at work, meetings, sleeping, and otherwise. The user needs to change such situations depending on the time of day. In the user situation profile, users can change the security level, receiving situation, and interest areas according to their situations.

### 2.2.1 Security Level

As users may not want to define independent privacy levels for every service that they use, there is a need for a common way to define security levels such that they apply across the widest possible range of services.

The profile settings provide an excellent opportunity to support users in controlling their security. Templates can have many default settings related to how to show to which extent the users want their profiles to be readable. The templates vary from allowing a user profile to be accessed by everybody, to asking for privileges every time, to asking for privilege at a first time and then trusting the provider, to not allowing anyone to view a user profile.

The security levels can vary depending on the situation and role of the user. Access control and authentication access to most profile data are only permitted in an authorized and secure manner, and there are methods available, for example, controlled by the mobile network operators or the servers, to check that the service, person, or organization accessing the data has the appropriate authorization to do so.

### 2.2.2 Receiving Situation

As shown in FIG. 5, the user can turn the receiving situation to be on or off in order to specify whether the user would like to receive anything or nothing according to his/her need.

### 2.2.3 Situation Preferences

According to what the user has chosen in the main preferences categories, as shown in FIG. 5, the user just adds his preferences in the situation preferences to specific the times he would like to receive a particular service.

### 2.2.4 Ring Tone

The feature of mobile ring tones specific to the received content or caller is transferred to the situation profile. For example, a user can specify when he chooses to be in a meeting, and therefore he does not need to change his profile at the meeting, and then change his/her ring tone to be silent. For example, the user may just specify that he is at a meeting, and all other services change automatically as he has specified previously in his profile to be in his work environment. In another example, the mobile device may use a formal ring tone for a work environment, and the mobile device may change the ring tone to a love song while at home.

### 2.3. Special Needs

As shown in FIG. 5, there is a setting when there is a limited ability of the mobile user, such as if the user is blind, deaf and dumb, etc. Such a setting identifies ways in which profiles could provide enhanced accessibility to information by providing options such as: listen to text for blind people, express speech in writing, for deaf and dumb people who cannot use sign language or other languages or gestures for deaf and dumb people; display large fonts on the mobile device for people with limited eyesight; display high contrast text and images for people with limited eyesight; and sign language or other deaf and dumb languages, symbols, and images to assist deaf and dumb mobile users.

### 2.4. Restricted Choices

As shown in FIG. 6, the restricted choices category provides a list of unwanted services for adults that should not be provided for a person who chooses from the category to be blocked, and also a list of unwanted services which should be restricted for all children and teenagers under 18 years of age.

### 3. Profile Password

As shown in FIG. 5, the profile password allows a user to set a password on his profile to eliminate others from changing or tampering with his profile in any manner, such as if the mobile has been stolen, or to prevent kids under 18 from changing their listed age in order to receive content they are not allowed to or supposed to view. In this manner, the profile should be set by the parents, and then they should set a password for the profile before providing the mobile device to their children.

### Mobile Devices for Children

Parents have many concerns, including protecting their children from potentially dangerous people, and limiting their access to certain content. In many families, parents of young children or teenagers define their children's profiles. Parents may want to limit the ways in which their children can modify their profiles, which can be done by defining a password on the profile to prevent their children from accessing and changing the profiles.

### Privileges Related to Children

The profiles of the mobile device or of the user may be set such that children have no privilege to use the tool for changing profiles, and therefore the children are unable to change the profile. Alternatively or in addition, parents have full privileges to use the profile changing tool and to update the profile. In another possible setting, children may change profiles, if the parents give their child this privilege by giving them the password of the profile.

### General Operations

In using the present invention, each mobile device is capable of performing a number of operations needed to maintain and employ the profile information.

### 1. View

The user should be able to view his profile after entering the correct password if he has set one previously.

### 2. Copy

When the user has more than one mobile device or when he buys a new device, he should be able to copy his information and transfer profile information from one device to another, rather than reset the profile information again. Some data is unsuitable to be copied and shared with other users, for example, security and receiving situation information and passwords or personal details, such as the user name, year of birth, etc., and this information should be automatically excluded from any copying to another person or organization.

### 3. Update

Profiles need to be updated regularly to adapt to new services, and to reflect user preferences.

### 4. Deletion

Before selling the mobile device or when the user wants to reset his profile information, the profile information should be deleted from the mobile device. Upon such deletion of profile information, a profile template is still available but empty.

### 5. Save

When the user enters his information or chooses his preferences, he should save his information before exiting the profile to start implementing the new information or preferences.

### Operation of the System and Method

When a user uses his mobile device to interact and access any network provider, the mobile device is detected, and then the service provider reads his profile information according to the security level the user has been set beforehand. Depending on such security levels, the service providers provide services tailored to the user's needs.

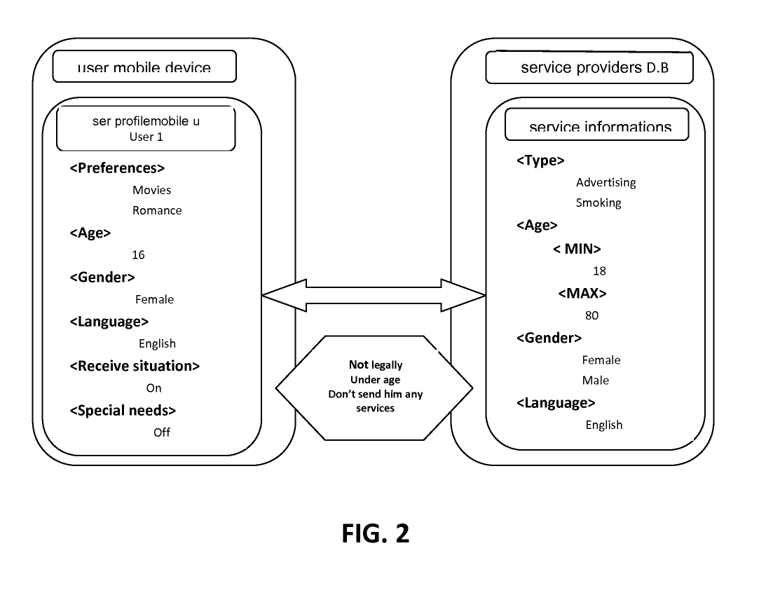

As described in connection with FIGS. 2-4, three example cases for three different situations illustrate how the service provider acts in each of these situations.

### CASE 1

As shown in FIG. 2, the system and method prevent illegal delivery of services to a user. For example, if a user, who is 16 years old, is interested in romance movies, and has his receiving situation set to be on, the service provider reads his information and wants to provide him with smoking advertisements while he is watching the movie.

In the prior art, such as situation was normal, since prior art service providers did not prevent such advertisements to underage users.

Using the system and method of the present invention using user profile information, including the age of the user, service providers respond to such profiles and prevent such a display of smoking advertisements while he is watching the movie. Accordingly, the system and method automatically protect children from watching any illegal content, such as smoking advertisements, while they are under 18 years, since the service provider will not provide smoking advertising to this child as a mobile user.

### CASE 2

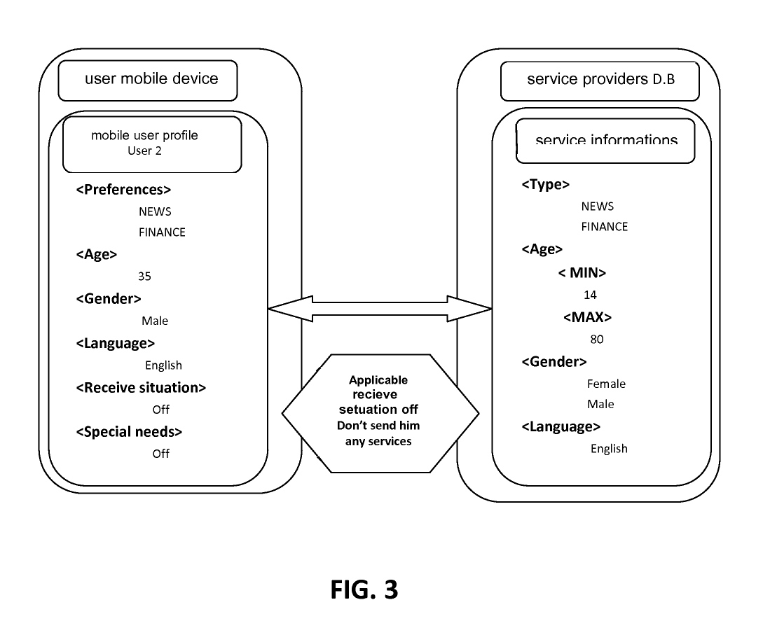

As shown in FIG. 3, the system and method prevent undesired delivery of services to a user. For example, in regular circumstances, the user would be able to receive content or information according to his profile, for example, the user is over 18 and so is permitted to receive smoking advertisements.

However, the user has set the receiving situation of his mobile device to be off, and so the service provider will not be able to send the user any services, and thus they will not disturb him.

### CASE 3

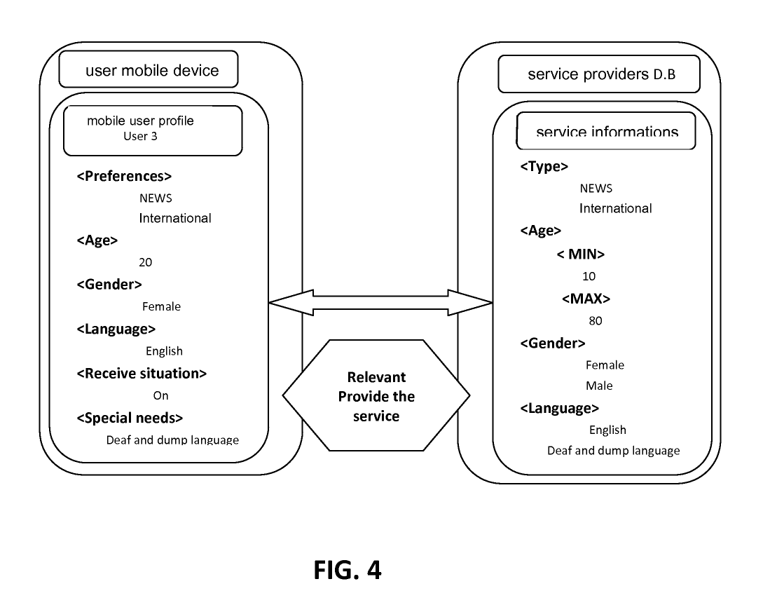

As shown in FIG. 4, the system and method permit delivery of services to a user. If the user profile information is relevant to the service providers, and the receiving situation is on, then the service provider is able to send the user the requested services at the time he needs or desires to receive such services, and such acceptable delivery will not disturb the user, since receiving situation of the user is on.

What is claimed is:

1. A system for controlling delivery of content to a user in a telecommunications network, the system comprising:
a mobile service provider for providing content and mobile services; and
a mobile device associated with a user, the mobile device having:
a communications interface for communicating with the mobile service provider over the telecommunications network; and
a memory storing a user profile associated with the user which specifies personal information of the user, including the age, gender, and interest areas of the user, and which specifies a security level associated with the user that shows to what extent the user would like the personal information to be readable by the mobile service providers and to what extent the user would like to receive mobile services and content, or whether the user does not want to accept any mobile services;
wherein the mobile service provider, responsive to the user profile, provides customized content and mobile services to the user according to the personal information, and which prevents illegal delivery of content and mobile services according to predetermined content prohibitions.
